(19) United States
(12) Patent Application Publication
(10) Pub. No.: US 2023/0259896 A1
(43) Pub. Date: Aug. 17, 2023

(54) RECOVERY SUPPORT SYSTEM

(71) Applicant: HONDA MOTOR CO., LTD., Tokyo (JP)

(72) Inventors: Noriyuki Ishida, Wako-shi (JP); Satoshi Suda, Wako-shi (JP); Hiroshi Iwakami, Wako-shi (JP)

(21) Appl. No.: 18/165,970

(22) Filed: Feb. 8, 2023

(30) Foreign Application Priority Data
Feb. 14, 2022 (JP) 2022-020495

(51) Int. Cl. G06Q 10/30; G06Q 30/0207; G05D 1/00; G05D 1/02; B64C 39/02; G06V 10/70

(52) U.S. Cl. CPC G06Q 10/30; G06Q 30/0207; G05D 1/0038; G05D 1/0246; B64C 39/024; G06V 10/70; B64U 2101/30

(57) ABSTRACT

A recovery support system includes: a photographic image acquisition unit configured to acquire a photographic image of a prescribed area captured by an image capturing unit provided in a mobile body; a recovery object determination unit configured to determine whether or not a determination object reflected in the photographic image is a recovery object; a recovery request unit configured to execute recovery request processing of requesting recovery of a specific object by the mobile body, the specific object being determined as the recovery object by the recovery object determination unit; and a reward providing unit configured to, when recovery of the specific object is performed by the mobile body in response to the recovery request processing, provide a recovery assignee who causes the mobile body to recover the specific object with reward corresponding to an aspect of the recovered specific object or time required for the recovery.

### INCORPORATION BY REFERENCE

The present application claims priority under 35 U.S.C. § 119 to Japanese Patent Application No. 2022-020495 filed on Feb. 14, 2022. The content of the application is incorporated herein by reference in its entirety.

### BACKGROUND OF THE INVENTION

### Field of the Invention

The present invention relates to a recovery support system.

### Description of the Related Art

In the past, a system has been proposed to recover refuse by dispatching a collecting truck or a collecting drone when a user requests recovery of refuse (see, for example, Japanese Patent Laid-Open No. 2020-87134).

In recent years, with increased concern on the natural environment, beach cleanup activities to clean the seashore have been implemented as activities to improve the natural environment. In the case of cleaning the seashore, an approach using the above system can be adopted to recover refuse. However, in the case of recovering recovery objects scattered over a wide area such as the seashore, it is desirable to secure a large number of agents to execute recovery processing.

An object of the present invention, which has been made in view of such background circumstances, is to provide a recovery support system capable of increasing the number of agents to execute recovery processing.

### SUMMARY OF THE INVENTION

As an aspect of accomplishing the above object, a recovery support system may be provided. The support system includes: a photographic image acquisition unit configured to acquire a photographic image of a prescribed area captured by an image capturing unit provided in a mobile body, a recovery object determination unit configured to determine whether or not a determination object reflected in the photographic image is a recovery object; a recovery request unit configured to execute recovery request processing of requesting recovery of a specific object in the prescribed area by the mobile body, the specific object being determined as the recovery object by the recovery object determination unit; and a reward providing unit configured to, when recovery of the specific object is performed by the mobile body in response to the recovery request processing, provide a recovery assignee who causes the mobile body to recover the specific object with reward corresponding to an aspect of the recovered specific object or time required for the recovery.

The above recovery support system may include a determination model generation unit configured to generate a determination model that determines whether or not the determination object is the recovery object, through machine learning using a sample image of the recovery object as teacher data. The recovery object determination unit may be configured to determine by using the determination model whether or not the determination object reflected in the photographic image is the recovery object.

In the above recovery support system, the recovery request unit may be configured to execute, as the recovery request processing, processing of:

transmitting, to a communication terminal used by a recovery collaborator who collaborates in recovery of the specific object, a marked photographic image so as to display the marked photographic image on a display unit of the communication terminal, the marked photographic image being the photographic image with an image part of the specific object being marked; and performing remote control of the mobile body based on operation instruction information transmitted from the communication terminal to cause the mobile body to recover the specific object.

The above recovery support system may include an object type recognition unit configured to recognize a type of the specific object recovered by the mobile body. The reward providing unit may be configured to determine a content of the reward according to the type of the specific object recognized by the object type recognition unit.

In the above recovery support system, the reward providing unit may be configured to determine a content of the reward according to frequency of recovery of the specific object by the mobile body performed by the recovery assignee.

The above recovery support system may include a first visitor flow change recognition unit configured to recognize change in visitor flow in the prescribed area. When the first visitor flow change recognition unit recognizes increase in the visitor flow in the prescribed area after recovery of the specific object by the mobile body, the reward providing unit may be configured to make the reward higher than when the first visitor flow change recognition unit does not recognize the increase in the visitor flow in the prescribed area.

In the above recovery support system, the prescribed area may be sandy ground, the recovery object may be refuse, the recovery support system may include a drawing request unit configured to execute drawing request processing of requesting drawing by a drawing robot on the sandy ground in a range where the refuse is recovered after recovery of the refuse is performed by the mobile body. When drawing by the drawing robot is performed on the sandy ground in the range where the refuse is recovered in response to the drawing request processing, the reward providing unit may be configured to provide reward to a drawing assignee who causes the drawing robot to perform drawing.

The above recovery support system may include a second visitor flow change recognition unit configured to recognize change in visitor flow in the prescribed area. When the second visitor flow change recognition unit recognizes increase in the visitor flow in the prescribed area after drawing by the drawing robot is performed on the sandy ground in the range where the refuse is recovered, the reward providing unit may be configured to make the reward higher than when the second visitor flow change recognition unit does not recognize the increase in the visitor flow in the prescribed area.

The above recovery support system can increase agents to execute recovery processing.

### BRIEF DESCRIPTION OF THE DRAWINGS

FIG. 1 is an explanatory view of an aspect of beach management by a beach management system;

FIG. 2 is a block diagram of the beach management system;

FIG. 3 is an explanatory view of a recovery object determination model;

FIG. 4 is a first flowchart of recovery support processing;

FIG. 5 is a second flowchart of the recovery support processing; and

FIG. 6 is a flowchart of drawing support processing.

### DETAILED DESCRIPTION OF THE PREFERRED EMBODIMENT

### 1. Beach Management Aspect

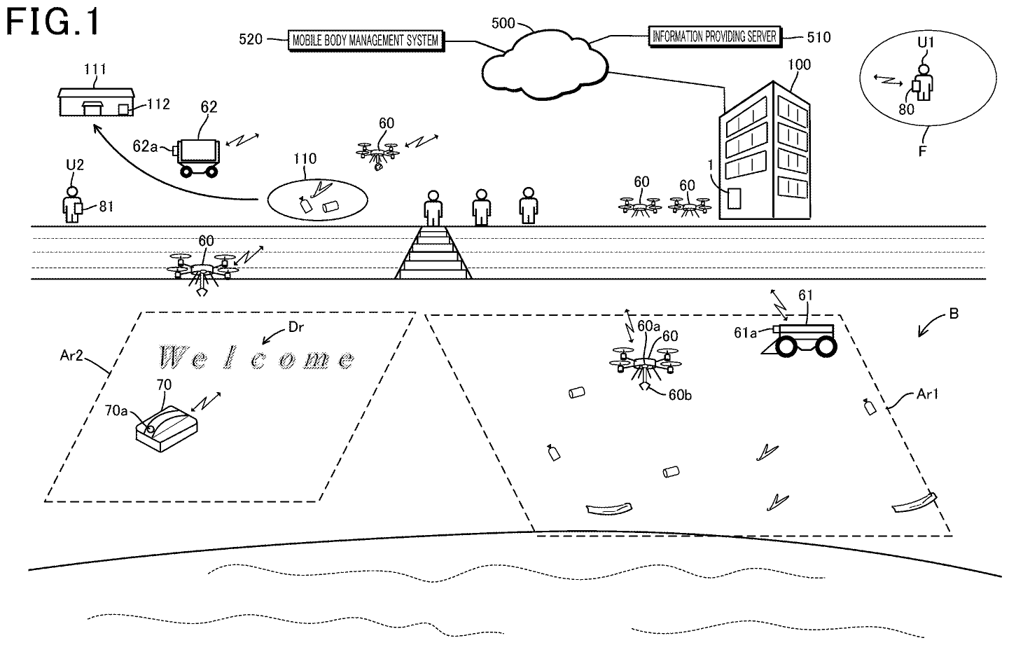

With reference to FIG. 1, description is given of a management aspect of an area B in a beach by a beach management system 1 in the present embodiment. The area B is sandy ground. The beach management system 1 is a computer system arranged in a management facility 100 for the area B.

The beach management system 1 communicates with a drone 60, a recovery vehicle 61, a collecting vehicle 62, a drawing robot 70, a communication terminal 80 of a recovery collaborator U1, a communication terminal 81 of a drawing assignee U2, an information providing server 510, a mobile body management system 520, and the like, through a communication network 500. The drone 60 includes a camera 60a, a recovery arm 60b, and unillustrated sensors, such as a global navigation satellite system (GNSS) sensor, an altitude sensor, a speed sensor, and an acceleration sensor, and is cable of a flight by automatic operation (autonomous flight). The recovery vehicle 61, the collecting vehicle 62 and the drawing robot 70 also include unillustrated sensors, such as a GNSS sensor, a speed sensor, and an acceleration sensor, in addition to the cameras 61a, 62a, and 70a, and are capable of a travel by automatic operation (autonomous traveling).

The mobile body management system 520 manages operation of the drone 60, the recovery vehicle 61, and the collecting vehicle 62. The beach management system 1 requests recovery of a recovery object in the area B to the mobile body management system 520 based on request information from local governments or beach management organizations, for example. The mobile body management system 520, which accepts the recovery request from the beach management system 1, arranges the drone 60, the recovery vehicle 61, and the collecting vehicle 62 to be used in the area B. An operator of the mobile body management system 520 corresponds to a recovery assignee assigned to recover the recovery object. The beach management system 1 may instruct activation of the drone 60, the recovery vehicle 61, and the collecting vehicle 62 via the mobile body management system 520. However, in the present embodiment, the beach management system 1 directly instructs activation of the drone 60, the recovery vehicle 61, and the collecting vehicle 62.

The beach management system 1 moves the drone 60 and the recovery vehicle 61 by remote control or automatic operation to recover recovery objects scattered across the area B. FIG. 1 illustrates the situation where the drone 60 and the recovery vehicle 61 recover the recovery objects scattered within a target area Ar1 in the area B. The recovery objects include refuse discarded by travelers visiting the area B or others, and wreckage such as driftwood. The drone 60 carries the recovered recovery objects to a collecting place 110. The collecting vehicle 62 collectively transfers the recovery objects gathered in the collecting place 110 to a recovery object disposal facility 111, where the recovery objects are disposed according to type.

The beach management system 1, which is located in a place F distanced from the area B, requests a recovery collaborator U1 who approves cleanup activities of the area B to recover the recovery objects by the drone 60 through remote control using the communication terminal 80. When the recovery collaborator U1 recovers the recovery objects in response to the request, the beach management system 1 provides reward to the recovery assignee (the operator of the mobile body management system 520) and the recovery collaborator U1. When the recovery objects are recovered through automatic operation of the drone 60 or remote control by the mobile body management system 520 without through the recovery collaborator U1, the reward is provided to the recovery assignee.

The beach management system 1 extracts, out of areas where the recovery objects have been recovered, the drawing adaptive area Ar2 where drawing by the drawing robot 70 is allowed. The beach management system 1 causes the drawing robot 70 to travel by automatic operation to perform drawing on the sand in the drawing adaptive area Ar2. FIG. 1 illustrates a picture Dr drawn on the sand.

The beach management system 1 requests a drawing assignee U2 who is an owner, an operator, or the like, of the drawing robot 70 to perform drawing in the drawing adaptive area Ar2 using the drawing robot 70. When the drawing assignee U2 performs drawing by the drawing robot 70 in response to the request, the beach management system 1 provides reward to the drawing assignee U2.

The beach management system 1 includes the functions of a mobile body control system that controls actuation of the mobile bodies, such as the drone 60, the recovery vehicle 61, and the collecting vehicle 62, a recovery support system that supports recovery of the recovery objects by the mobile bodies, a drawing robot control system that controls actuation of the drawing robot 70, and a drawing support system that supports drawing on the sandy ground by the drawing robot.

### 2. Configuration of Beach Management System

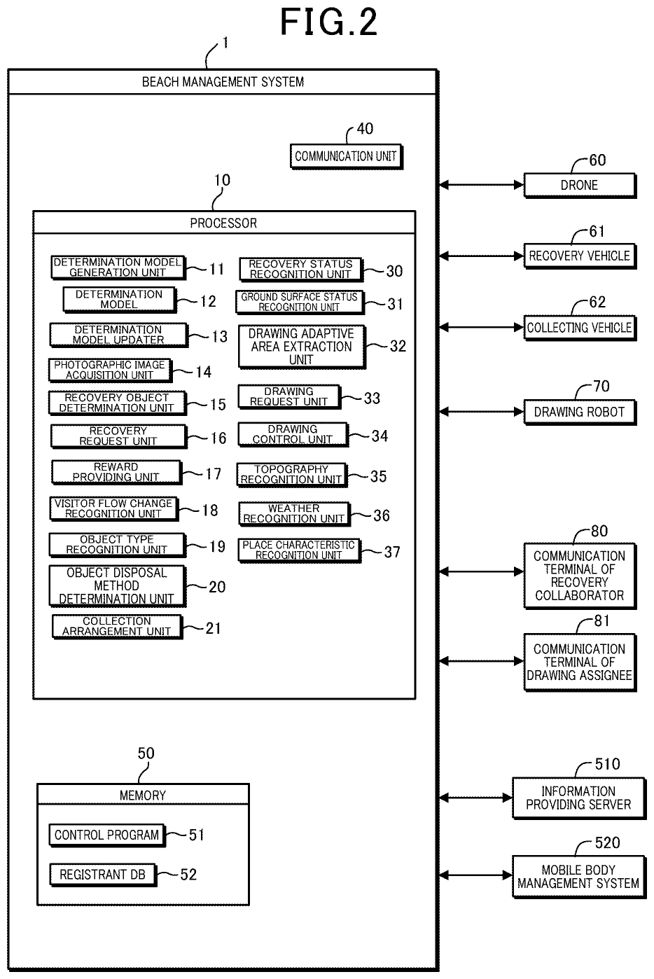

The configuration of the beach management system 1 will be described with reference to FIG. 2. The beach management system 1 is a computer system composed of a communication unit 40, a processor 10, and a memory 50. The communication unit 40 communicates with the drone 60, the recovery vehicle 61, the collecting vehicle 62, the drawing robot 70, the communication terminal 80 of the recovery collaborator U1, the communication terminal 81 of the drawing assignee U2, the information providing server 510, the mobile body management system 520, and the like, through the communication network 500 (see FIG. 1). When a distance to a communication partner is short, direct communication may be performed without through the communication network 500.

The memory 50 stores a control program 51 for controlling the overall actuation of the beach management system 1 and a registrant database (DB) 52 storing information on registrants (recovery collaborators, drawing assignees) who have applied for collaboration in recovering recovery objects or for acceptance of drawing in the area B.

By reading and executing the control program 51, the processor 10 functions as a determination model generation unit 11, a determination model 12, a determination model updater 13, a photographic image acquisition unit 14, a recovery object determination unit 15, a recovery request unit 16, a reward providing unit 17, a visitor flow change recognition unit 18, an object type recognition unit 19, an object disposal method determination unit 20, and a collection arrangement unit 21.

The processor 10 further functions as a recovery status recognition unit 30, a ground surface status recognition unit 31, a drawing adaptive area extraction unit 32, a drawing request unit 33, a drawing control unit 34, a topography recognition unit 35, a weather recognition unit 36, and a place characteristic recognition unit 37.

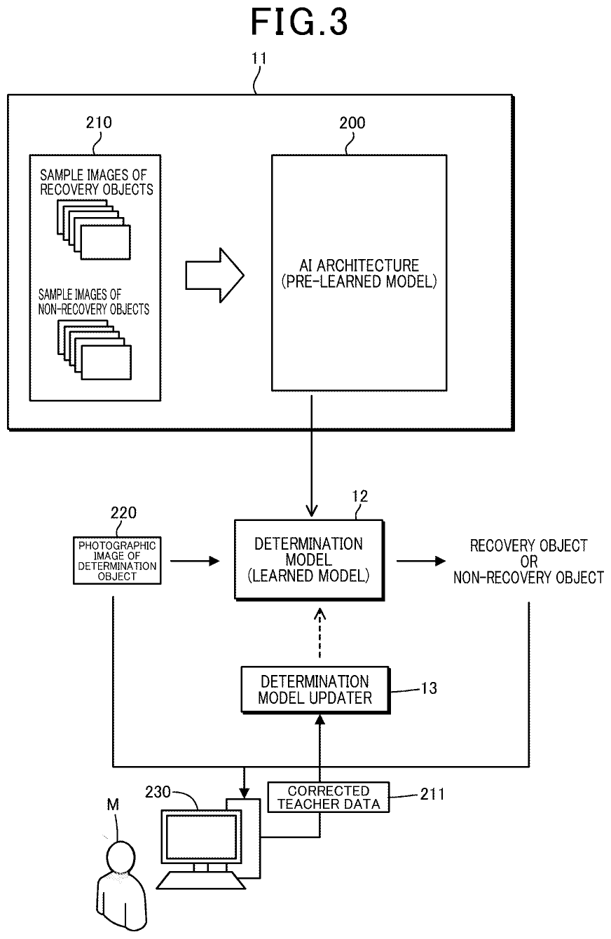

Here, with reference to FIG. 3, the processing by the determination model generation unit 11 and the determination model updater 13 will be described. The determination model generation unit 11 inputs teacher data 210 into an artificial intelligence (AI) architecture (pre-learned model) 200, and causes the AI architecture 200 to execute machine learning so as to generate a determination model (learned model) 12. The teacher data 210 includes sample images of recovery objects (such as refuse and wreckage) and sample images of non-recovery objects (such as plants and marine organisms) in association with determination results (recovery object or non-recovery object). Sample images may be the images obtained by photographing the objects actually recovered in the past.

The determination model 12 receives input of a photographic image 220 including a determination object captured by the drone 60, and outputs a determination result indicating whether or not the determination object is a recovery object. An operator M of the beach management system 1 uses a monitor device 230 such as a personal computer to examine the photographic image 220 and the determination result by the determination model 12. When the determination result is incorrect, the operator M corrects the determination result and generates corrected teacher data 211. The determination model updater 13 performs relearning of the determination model 12 using the corrected teacher data 211, and updates the determination model 12. The relearning can improve the accuracy of determination of the recovery objects by the determination model 12.

The photographic image acquisition unit 14 receives and acquires, through the communication unit 40, photographic images which are captured by the cameras (image capturing units) 60a, 61a, and 70a provided in the drone 60, the recovery vehicle 61, and the drawing robot 70, and are transmitted from the drone 60, the recovery vehicle 61, and the drawing robot 70. The recovery object determination unit 15 determines by using the determination model 12 whether or not a determination object reflected in the photographic images acquired by the photographic image acquisition unit 14 is a recovery object. The recovery request unit 16 requests the recovery collaborator U1 to recover a specific object that is determined as the recovery object by the recovery object determination unit 15.

Here, when any non-recovery object which is also an object to be protected (for example, marine organisms such as sea turtle eggs) is extracted from the photographic images acquired by the photographic image acquisition unit 14, it is also possible to provide information on the area where the object to be protected is present to public authorities which manage the seashore and to request implementation of regulation for prohibiting access to the area where the objected to be protected is present. Alternatively, the drone 60 itself, which photographs images, may draw a notation indicating it is a restricted area on the beach. For example, a graphic symbol, such as a square or a circle encircling a spawning area of a sea turtle, may be drawn on the beach, or a character string “No Entry” may be drawn on the beach.

The reward providing unit 17 provides reward to a recovery assignee (an operator of the mobile body management system 520) and the recovery collaborator U1 who perform recovery of the recovery objects by the drone 60. The reward includes cash, electronic money, points, coupons, and tickets for facilities. The visitor flow change recognition unit 18 recognizes change in visitor flow in the area B based on the photographic image of the area B acquired by the photographic image acquisition unit 14 and based on visitor flow information provided from the information providing server 510, and the like.

The object type recognition unit 19 recognizes the type of a specific object recovered by the drone 60 or the recovery vehicle 61 by image analysis of the specific object. The object disposal method determination unit 20 determines a disposal method of the recovered specific object according to the type of the specific object. The disposal method includes recycling, reuse, incineration, and the like. The collection arrangement unit 21 arranges transfer of the specific objects collected in the collecting place 110 by the collecting vehicle 62. The collection arrangement unit 21 transmits information on the disposal methods of the specific objects determined by the object disposal method determination unit 20 to a disposal system 112 in the disposal facility 111. Hence, each specific object is disposed appropriately in the disposal facility 111.

The reward providing unit 17 determines the content of the reward under following conditions 1-1 to 1-5.

1-1. As the size of the specific object is larger, the reward is made higher.

1-2. As the weight of the specific object is heavier, the reward is made higher.

1-3. As the value according to the type of the specific object is higher, the reward is made higher.

1-4. As the time required for recovery is longer, the reward is made higher.

1-5. When an increase in visitor flow in the area B is recognized by the visitor flow change recognition unit 18 after execution of recovery, the reward is made higher than when the increase in visitor flow is not recognized.

The recovery status recognition unit 30 recognizes the area where recovery objects are recovered based on the photographic image of the area B acquired by the photographic image acquisition unit 14 or based on the status of execution of recovery in response to the request of the recovery request unit 16. The ground surface status recognition unit 31 recognizes the status of the ground surface in the area B based on the photographic image of the area B acquired by the photographic image acquisition unit 14. The ground surface status recognition unit 31 recognizes, as the status of the ground surface of the area B, the degree of irregularities of sandy ground, the presence or absence of hollows, and the presence or absence of obstacles (such as tetrapods, woods, and concrete).

The drawing adaptive area extraction unit 32 extracts, out of the areas recognized by the recovery status recognition unit 30 as the areas where recovery objects have been recovered, a drawing adaptive area where drawing by the drawing robot 70 is allowed according to the status of the ground surface recognized by the ground surface status recognition unit 31. The drawing adaptive area, for example, is a relatively flat area where the drawing robot 70 can travel.

Here, the drawing robot 70 may travel by itself to search for the drawing adaptive area based on the photographic images by the camera 70a provided in the drawing robot 70 and based on detection information from various sensors (such as an obstacle sensor, and an inclination sensor) provided in the drawing robot 70, and the like.

The drawing request unit 33 requests to the drawing assignee U2 to perform drawing on the drawing adaptive area by the drawing robot 70 based on, for example, request information from local governments and beach management organizations. The drawing control unit 34 performs drawing by the drawing robot 70 on the sand by determining a drawing design (drawing conditions), transmitting information on the drawing conditions to the drawing robot 70, and controlling the drawing robot 70 to travel based on the drawing conditions. The topography recognition unit 35 recognizes the topology (such as inclinations and hills) of the area B based on the topographic information or the like on the area B provided from the information providing server 510.

The weather recognition unit 36 recognizes present weather or future weather forecast of the area B based on weather information or the like on the area B provided from the information providing server 510. The place characteristic recognition unit 37 recognizes the characteristics (such as degree of moisture of sand, and size of sand grains) of the place where the drawing adaptive area is located, based on regional information or the like on the area B provided from the information providing server 510. The place characteristic recognition unit 37 may also recognize the characteristics of the place where the drawing adaptive area is located based on the photographic image of the area B transmitted from the drone 60 or the drawing robot 70.

The drawing control unit 34 determines the drawing conditions under following conditions 2-1 to 2-3, based on the recognition status by the topography recognition unit 35, the weather recognition unit 36, and the place characteristic recognition unit 37.

2-1. When the drawing adaptive area is inclined, and when the drawing adaptive area is on a hill, a picture is designed so as to make use of the inclination or the shape of the hill.

2-2. When there is bad weather (strong wind, rainy weather), and when there is a forecast of bad weather, a design more resistant to bad weather is adopted. For example, designs with a groove drawn to be deep and wide, designs with patterns not too fine, and the like, are adopted.

2-3. When drawing is easy and a drawn picture does not easily disappear, such as in the case where the drawing adaptive area is humid, and the size of sand grains is large, designs with fine patterns may be incorporated.

The reward providing unit 17 determines the content of the reward under following conditions 3-1 to 3-5 according to the recognition status by the topography recognition unit 35, the weather recognition unit 36, and the place characteristic recognition unit 37, the difficulty of drawing and the visitor flow change recognition unit 18.

3-1. When the drawing adaptive area is inclined or when the drawing adaptive area is on a hill, the difficulty of drawing by the drawing robot 70 is higher, and therefore the reward is made higher than when the drawing adaptive area is flat.

3-2. When there is bad weather (strong wind, rainy weather), and when there is a forecast of bad weather, it is needed to draw deep grooves, or the like, which are more resistant to bad weather, and this increases the time required for drawing. Therefore, the reward is made higher than when there is no bad weather and when there is no forecast of bad weather.

3-3. When drawing is easy, such as in the case where the drawing adaptive area is humid, and the size of sand grains is large, the reward is made lower than when drawing is difficult, such as in the case where a dry level is high or in the case where the sand grains are small.

3-4. Depending on the difficulty according to man-hour of drawing itself, such as in the case where a drawing design is complex, the size of a picture to be drawn is large, and the range of the drawing adaptive area is wide, the reward is made higher as the difficulty is higher.

3-5. When an increase in visitor flow in the area B is recognized by the visitor flow change recognition unit 18 after execution of recovery, the reward is made higher than when the increase in visitor flow is not recognized.

### 3. Recovery Support Processing

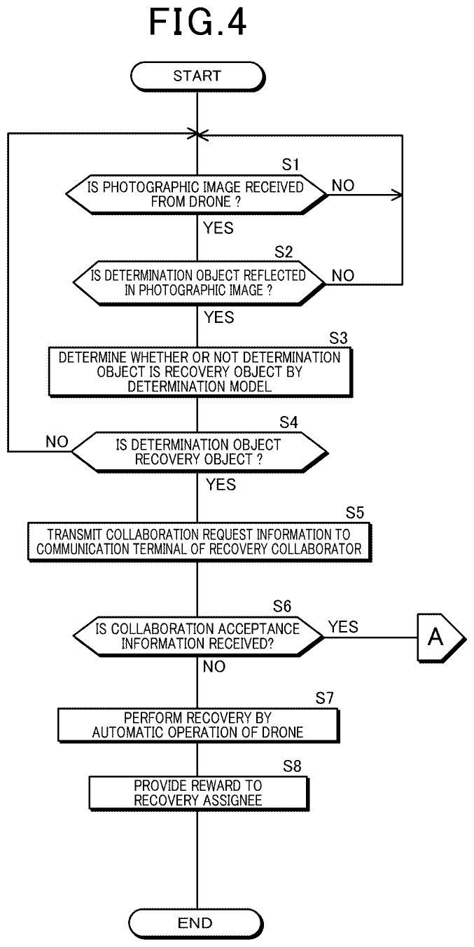

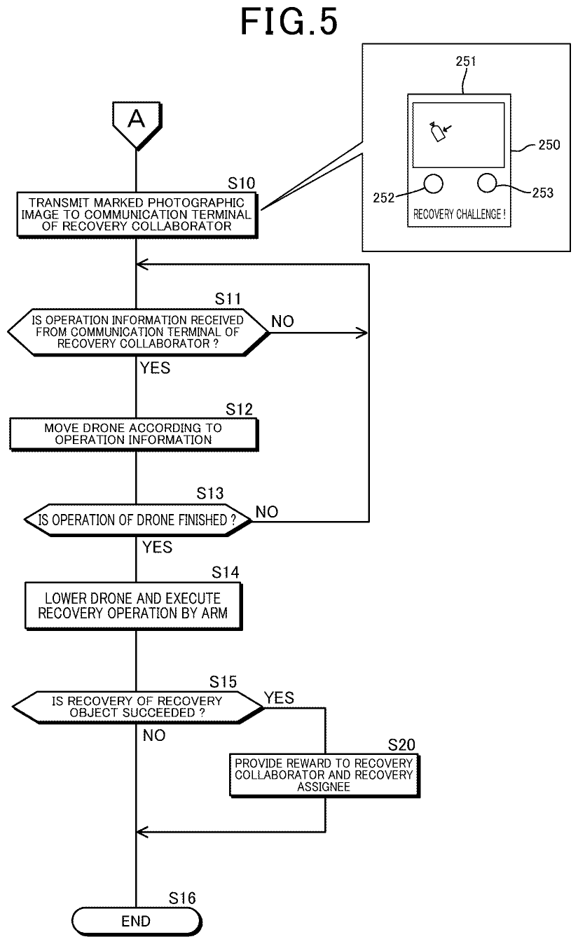

According to the flowcharts shown in FIGS. 4 and 5, the recovery support processing performed by the beach management system 1 will be described. Hereinafter, description is given of the case of performing recovery by the drone 60 in collaboration with the recovery collaborator U1 in the situation shown in FIG. 1.

In step S1 in FIG. 4, upon receipt of a photographic image transmitted from the drone 60, the photographic image acquisition unit 14 advances the processing to step S2. The drone 60 that has transmitted the photographic image waits at a photographing point until it is determined that a determination object is not a recovery object in step S4 described later, or until recovery is completed in step S7 or step S14.

In step S2, the recovery object determination unit 15 performs image processing on the photographic image and determines whether or not a determination object is reflected in the photographic image. When the determination object is reflected in the photographic image, the recovery object determination unit 15 advances the processing to step S3, and when the determination object is not reflected in the photographic image, the recovery object determination unit 15 advances the processing to S1.

In step S3, the recovery object determination unit 15 inputs the photographic image of the determination object into the determination model 12 to determine whether or not the determination object is a recovery object. In following step S4, the recovery object determination unit 15 advances the processing to step S5 when it is determined that the determination object is the recovery object. When it is determined that the determination object is not the recovery object, the recovery object determination unit 15 advances the processing to step S1.

In step S5, collaboration request information for requesting collaboration in recovery is transmitted to the communication terminal 80 of the recovery collaborator U1 who is a registrant applied for collaboration in recovery and registered in the registrant DB 52. In following step S6, when the recovery request unit 16 receives recovery acceptance information from the communication terminal 80, the recovery request unit 16 advances the processing to step S10 in FIG. 5. On the other hand, when the recovery request unit 16 does not receive the recovery acceptance information, the recovery request unit 16 advances the processing to step S7 to recover the recovery object by automatic operation of the drone 60. In following step S8, the reward providing unit 17 provides reward to the recovery assignee as described above.

In step S10 in FIG. 5, the recovery request unit 16 transmits to the communication terminal 80 of the recovery collaborator U1 a marked photographic image 251 with an image part of a specific object determined as a recovery object being marked by an arrow. Marking may be given by encircling the image part of the specific object, increasing the brightness of the image part of the specific object, and the like. When the recovery collaborator U1 determines that the marked specific object is not the recovery object, the recovery collaborator U1 can transmits incorrect determination information notifying that the determination result is incorrect to the beach management system 1 through the communication terminal 80. The determination model updater 13 can update the determination model 12 by performing relearning of the determination model 12 using the image of the object, which is notified by the incorrect determination information as the incorrectly determined object, as corrected teacher data.

The communication terminal 80, which has received the marked photographic image 251, displays on the display unit that is a touch panel a remote control screen 250 including a marked photographic image 251, a right-left button 252 to move the drone 60 in the direction corresponding to a right-left direction of the screen, and an up-down button 253 to move the drone 60 in the direction corresponding to an up-down direction of the screen.

The remote control screen 250 is designed to allow the drone 60 to recover the recovery object in a similar manner to a crane game, and the recovery collaborator U1 can operate the right-left button 252 and the up-down button 253 only once. When the operation of the right-left button 252 and the up-down button 253 is finished, the recovery request unit 16 lowers the drone 60 at this point of time to allow the arm 60b to execute recovery operation of the recovery object.

Through a loop process of subsequent steps S11 to S13, the recovery request unit 16 advances the processing to step S12 upon receipt of operation information on the right-left button 252 or the up-down button 253 performed by the recovery collaborator U1 in step S11, so as to move the drone 60 according to the operation. In following step S13, the recovery request unit 16 advances the processing to step S13 when the operation of the drone 60 (operation of both the right-left button 252 and the up-down button 253) by the recovery collaborator U1 is finished. When the operation of the drone 60 by the recovery collaborator U1 is not finished, the recovery request unit 16 advances the processing to step S11.

In step S14, the recovery request unit 16 lowers the drone 60 and executes the recovery operation of the recovery object. In following step S15, the recovery request unit 16 advances the processing to step S20 when recovery of the recovery object is succeeded, and when recovery of the recovery object is failed, the recovery request unit 16 advances the processing to step S16.

In step S20, the reward providing unit 17 provides reward to the recovery collaborator U1 and the recovery assignee as described above. When the recovery collaborator U1 fails to recover the recovery object, the recovery request unit 16 may re-execute steps S10 to S14 to allow the recovery collaborator U1 to challenge again. When the recovery collaborator U1 erroneously recovers something that should not be recovered, a penalty may be imposed on the recovery collaborator U1.

In the processing in the flowchart shown in FIG. 4, when the recovery object is determined from the photographic image taken by the drone 60, the collaboration request information is transmitted to the communication terminal 80 of the recovery collaborator U1 to request recovery operation. However, it is possible to request the recovery collaborator U1 to perform the operation from the stage of searching for the recovery object. In this case, the recovery collaborator U1 remotely controls the drone 60 to fly through the communication terminal 80, and when a recovery object is found by checking the images transmitted from the drone 60, the recovery collaborator U1 remotely controls the drone 60 through the communication terminal 80 to recover the recovery object.

### 4. Drawing Support Processing

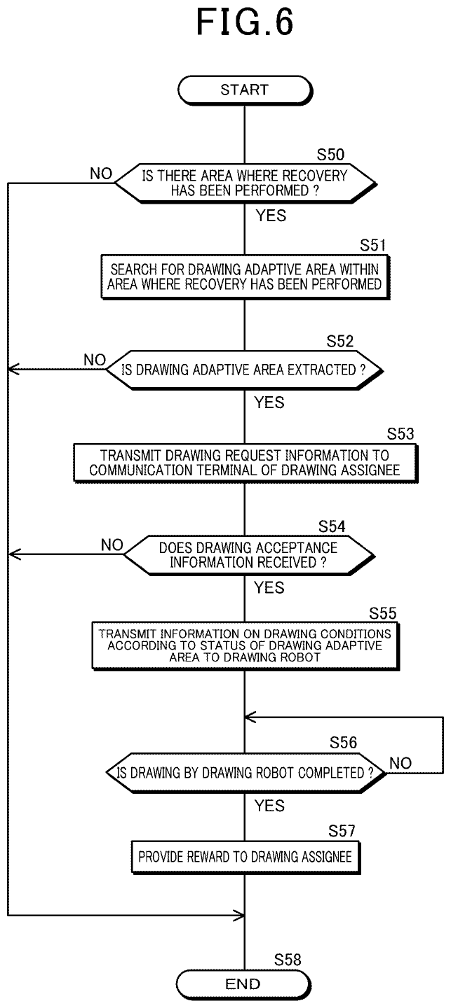

Description is given of the drawing support processing executed by the beach management system 1 according to the flowchart shown in FIG. 6.

In step S50 of FIG. 6, the recovery status recognition unit 30 determines whether or not there is an area where recovery of the recovery object has been performed. When there is the area where the recovery has been performed, the recovery status recognition unit 30 advances the processing to step S51. When there is no area where the recovery has been performed, the recovery status recognition unit 30 advances the processing to step S58. In step S51, the drawing adaptive area extraction unit 32 searches for a drawing adaptive area within the area where the recovery of the recovery object has been performed, from the photographic image by the drone 60 acquired by the photographic image acquisition unit 14.

In following step S52, the drawing adaptive area extraction unit 32 advances the processing to step S53 when the drawing adaptive area is extracted, and advance the processing to step S58 when the drawing adaptive area is not extracted. In step S53, the drawing request unit 33 transmits drawing request information to request drawing on the drawing adaptive area by the drawing robot 70 to the communication terminal 81 of the drawing assignee U2.

In following step S54, upon receipt of drawing acceptance information from the communication terminal 81 of the drawing assignee U2, the drawing request unit 33 advances the processing to step S55. When receiving no drawing acceptance signal from the communication terminal 81 of the drawing assignee U2, the drawing request unit 33 advances the processing to step S58. In subsequent step S55, the drawing control unit 34 transmits to the drawing robot 70 information on the drawing design (drawing conditions) according to the status of the drawing adaptive area. As a result, drawing on the drawing adaptive area is performed by the drawing robot 70.

In following step S56, the drawing request unit 33 advances the processing to step S57 when the drawing on the drawing adaptive area by the drawing robot 70 is completed. In step S57, the reward providing unit 17 provides reward to the drawing assignee U2 as described above.

### 5. Other Embodiments

In the above embodiment, an example is shown in which the function of the mobile body control system to control the operation of the mobile bodies (the drone 60 and the recovery vehicle 61) is composed of the beach management system 1. However, all or a part of the mobile body control system may be composed of a controller provided in each of the mobile bodies. The controller of the mobile body is constituted of a processor, a memory, a communication circuit, and the like, and the processor executes control programs stored in the memory to function as, for example, the determination model 12, the photographic image acquisition unit 14, the recovery object determination unit 15, and the like, in order to control the recovery operation of the recovery object.

In the above embodiment, an example is shown in which the function of the drawing robot control system to control the actuation of the drawing robot 70 is composed of the beach management system 1. However, all or part of the drawing robot control system may be composed of the controller provided in the drawing robot 70. The controller of the drawing robot 70 is constituted of a processor, a memory, a communication circuit, and the like, and the processor executes a control program stored in the memory to function as, for example, the ground surface status recognition unit 31, the drawing adaptive area extraction unit 32, the drawing request unit 33, and the like, in order to control the drawing operation on the sand by the drawing robot 70.

In the above embodiment, an example is shown in which the drawing adaptive area extraction unit 32 searches for the drawing adaptive area within the area where recovery of the recovery object has been performed. However, the drawing adaptive area extraction unit 32 may search for the drawing adaptive area within areas, such as sandy beaches or sandy ground in parks, in addition to the area where the recovery object has been recovered.

For easy understanding of the present invention, FIG. 2 is a schematic view showing the configuration of the beach management system 1 which is categorized according to main processing contents, and the beach management system 1 may be configured according to other categories. The processing of each component member may be executed by a single hardware unit or may be executed by a plurality of hardware units. The processing by each component member shown in FIGS. 4 to 6 may be executed by a single program or may be executed by a plurality of programs.

The area B corresponds to the prescribed area in the present disclosure. The drone 60 and the recovery vehicle correspond to the mobile body in the present disclosure. The visitor flow change recognition unit includes the configuration of a first visitor flow change recognition unit that recognizes change in visitor flow due to recovery in the present disclosure and a second visitor flow change recognition unit that recognizes change in visitor flow due to drawing in the present disclosure.

### 6. Configuration Supported by Embodiments

The embodiments disclosed are specific examples of the following configurations.

(Configuration 1) A recovery support system includes: a photographic image acquisition unit configured to acquire a photographic image of a prescribed area captured by an image capturing unit provided in a mobile body; a recovery object determination unit configured to determine whether or not a determination object reflected in the photographic image is a recovery object; a recovery request unit configured to execute recovery request processing of requesting recovery of a specific object in the prescribed area by the mobile body, the specific object being determined as the recovery object by the recovery object determination unit; and a reward providing unit configured to, when recovery of the specific object is performed by the mobile body in response to the recovery request processing, provide a recovery assignee who causes the mobile body to recover the specific object with reward corresponding to an aspect of the recovered specific object or time required for the recovery.

The recovery support system of the configuration 1 can increase agents to execute recovery processing by providing reward to a recovery assignee.

(Configuration 2) The recovery support system according to the configuration 1 includes a determination model generation unit configured to generate a determination model that determines whether or not the determination object is the recovery object, through machine learning using a sample image of the recovery object as teacher data. The recovery object determination unit determines by using the determination model whether or not the determination object reflected in the photographic image is the recovery object.

The recovery support system of the configuration 2 can accurately recognize and recover the recovery object.

(Configuration 3) In the recovery support system according to the configuration 1 or the configuration 2, the recovery request unit executes, as the recovery request processing, processing of transmitting, to a communication terminal used by a recovery collaborator who collaborates in recovery of the specific object, a marked photographic image so as to display the marked photographic image on a display unit of the communication terminal, the marked photographic image being the photographic image with an image part of the specific object being marked, and performing remote control of the mobile body based on operation instruction information transmitted from the communication terminal so as to recover the specific object by the mobile body.

The recovery support system of the configuration 3 enables a recovery collaborator located in a remote area to collaborate in recovery, and can thereby promote increase in the number of people involved in the recovery.

(Configuration 4) The recovery support system described according to any one of the configurations from the configuration 1 to the configuration 3 includes an object type recognition unit configured to recognize a type of the specific object recovered by the mobile body. The reward providing unit determines a content of the reward according to the type of the specific object recognized by the object type recognition unit.

The recovery support system in the configuration 4 can determine the content of reward according to the value of the recovered specific object.

(Configuration 5) In the recovery support system according to any one of the configurations from the configuration 1 to the configuration 4, the reward providing unit determines a content of the reward according to frequency of recovery of the specific object by the mobile body performed by the recovery assignee.

The recovery support system in the configuration 5 can encourage participation in recovery by taking actions such as increasing the reward provided to the recovery assignee who actively contributes to the recovery.

(Configuration 6) The recovery support system according to any one of the configurations from the configuration 1 to the configuration 5 includes a first visitor flow change recognition unit configured to recognize change in visitor flow in the prescribed area. When the first visitor flow change recognition unit recognizes increase in the visitor flow in the prescribed area after recovery of the specific object by the mobile body, the reward providing unit makes the reward higher than when the first visitor flow change recognition unit does not recognize the increase in the visitor flow in the prescribed area.

The recovery support system in the configuration 6 can take actions such as increasing the reward to the recovery assignee, when it is recognized that the recovery of the recovery object contributes to increase in visitor flow.

(Configuration 7) In the recovery support system according to any one of the configurations from the configuration 1 to the configuration 6, the prescribed area is sandy ground and the recovery object is refuse, the recovery support system includes a drawing request unit configured to execute drawing request processing of requesting drawing by a drawing robot on the sandy ground in a range where the refuse is recovered after recovery of the refuse is performed by the mobile body, and when the drawing robot performs drawing on the sandy ground in the range where the refuse is recovered in response to the drawing request processing, the reward providing unit provides reward to a drawing assignee who causes the drawing robot to perform drawing.

The recovery support system in the configuration 7 can generate the effect of attracting customers to the prescribed area by performing drawing by the drawing robot on the sandy ground which is prepared for drawing by recovery of refuse.

(Configuration 8) The recovery support system according to the configuration 7 includes a second visitor flow change recognition unit configured to recognize change in visitor flow in the prescribed area. When the second visitor flow change recognition unit recognizes increase in the visitor flow in the prescribed area after drawing by the drawing robot is performed on the sandy ground in the range where the refuse is recovered, the reward providing unit makes the reward higher than when the second visitor flow change recognition unit does not recognize the increase in the visitor flow in the prescribed area.

According to the recovery support system in the configuration 8, when it is recognized that the drawing contributes to increase in visitor flow, the reward to the drawing assignee is increased, and this can increase the motivation of the drawing assignee to perform drawing.

### REFERENCE SIGNS LIST

1 . . . BEACH MANAGEMENT SYSTEM (MOBILE BODY CONTROL SYSTEM, RECOVERY SUPPORT SYSTEM, DRAWING ROBOT CONTROL SYSTEM, DRAWING SUPPORT SYSTEM), 10 . . . PROCESSOR, 11 . . . DETERMINATION MODEL GENERATION UNIT, 12 . . . DETERMINATION MODEL, 13 . . . DETERMINATION MODEL UPDATER, 14 . . . PHOTOGRAPHIC IMAGE ACQUISITION UNIT, 15 . . . RECOVERY OBJECT DETERMINATION UNIT, 16 . . . RECOVERY REQUEST UNIT, 17 . . . REWARD PROVIDING UNIT, 18 . . . VISITOR FLOW CHANGE RECOGNITION UNIT, 19 . . . OBJECT TYPE RECOGNITION UNIT, 20 OBJECT DISPOSAL METHOD DETERMINATION UNIT, 21 . . . COLLECTION ARRANGEMENT UNIT, 30 . . . RECOVERY STATUS RECOGNITION UNIT, 31 . . . GROUND SURFACE STATUS RECOGNITION UNIT, 32 . . . DRAWING ADAPTIVE AREA EXTRACTION UNIT, 33 . . . DRAWING REQUEST UNIT, 34 . . . DRAWING CONTROL UNIT, 35 . . . TOPOGRAPHY RECOGNITION UNIT, 36 . . . WEATHER RECOGNITION UNIT, 37 . . . PLACE CHARACTERISTIC RECOGNITION UNIT, 50 . . . MEMORY, 51 . . . CONTROL PROGRAM, 52 . . . REGISTRANT DB, 60 . . . DRONE, 61 . . . RECOVERY VEHICLE, 62 . . . COLLECTING VEHICLE, 70 . . . DRAWING ROBOT, 80 . . . COMMUNICATION TERMINAL OF RECOVERY COLLABORATOR, 81 . . . COMMUNICATION TERMINAL OF DRAWING ASSIGNEE, 200 . . . AI ARCHITECTURE, 210 . . . TEACHER DATA, 500 . . . COMMUNICATION NETWORK, 510 . . . INFORMATION PROVIDING SERVER, 520 . . . MOBILE BODY MANAGEMENT SYSTEM, B . . . BEACH, AR2 DRAWING ADAPTIVE AREA, U1 . . . RECOVERY COLLABORATOR, U2 . . . DRAWING ASSIGNEE

What is claimed is:

1. A recovery support system, comprising:
a photographic image acquisition unit configured to acquire a photographic image of a prescribed area captured by an image capturing unit provided in a mobile body;
a recovery object determination unit configured to determine whether or not a determination object reflected in the photographic image is a recovery object;
a recovery request unit configured to execute recovery request processing of requesting recovery of a specific object in the prescribed area by the mobile body, the specific object being determined as the recovery object by the recovery object determination unit; and
a reward providing unit configured to, when the specific object is recovered by the mobile body in response to the recovery request processing, provide a recovery assignee who causes the mobile body to recover the specific object with reward corresponding to an aspect of the recovered specific object or time required for the recovery.

2. The recovery support system according to claim 1, comprising a determination model generation unit configured to generate a determination model that determines whether or not the determination object is the recovery object, through machine learning using a sample image of the recovery object as teacher data, wherein
the recovery object determination unit determines by using the determination model whether or not the determination object reflected in the photographic image is the recovery object.

3. The recovery support system according to claim 1, wherein the recovery request unit executes, as the recovery request processing, processing of
transmitting, to a communication terminal used by a recovery collaborator who collaborates in recovery of the specific object, a marked photographic image so as to display the marked photographic image on a display unit of the communication terminal, the marked photographic image being the photographic image with an image part of the specific object being marked, and
performing remote control of the mobile body based on operation instruction information transmitted from the communication terminal so as to recover the specific object by the mobile body.

4. The recovery support system according to claim 1, comprising an object type recognition unit configured to recognize a type of the specific object recovered by the mobile body, wherein
the reward providing unit determines a content of the reward according to the type of the specific object recognized by the object type recognition unit.

5. The recovery support system according to claim 1, wherein the reward providing unit determines a content of the reward according to frequency of recovery of the specific object by the mobile body performed by the recovery assignee.

6. The recovery support system according to claim 1, comprising a first visitor flow change recognition unit configured to recognize change in visitor flow in the prescribed area, wherein
when the first visitor flow change recognition unit recognizes increase in the visitor flow in the prescribed area after recovery of the specific object by the mobile body, the reward providing unit makes the reward higher than when the first visitor flow change recognition unit does not recognize the increase in the visitor flow in the prescribed area.

7. The recovery support system according to claim 1, wherein
the prescribed area is sandy ground,
the recovery object is refuse,
the recovery support system comprises a drawing request unit configured to execute drawing request processing of requesting drawing by a drawing robot on the sandy ground in a range where the refuse is recovered after recovery of the refuse is performed by the mobile body, and
when drawing by the drawing robot is performed on the sandy ground in the range where the refuse is recovered in response to the drawing request processing, the reward providing unit provides reward to a drawing assignee who causes the drawing robot to perform drawing.

8. The recovery support system according to claim 7, comprising a second visitor flow change recognition unit configured to recognize change in visitor flow in the prescribed area, wherein
when the second visitor flow change recognition unit recognizes increase in the visitor flow in the prescribed area after drawing by the drawing robot is performed on the sandy ground in the range where the refuse is recovered, the reward providing unit makes the reward higher than when the second visitor flow change recognition unit does not recognize the increase in the visitor flow in the prescribed area.
